(19) United States
(12) Patent Application Publication
(10) Pub. No.: US 2009/0039712 A1
(43) Pub. Date: Feb. 12, 2009

(54) SAFE START-UP INTERFACE FOR A VEHICLE WITH AN ELECTRIC STARTER

(75) Inventors: Thierry Czarnyszka, Paris (FR); Eric Parent, Saint Cloud (FR)

Correspondence Address: BROWDY AND NEIMARK, P.L.L.C.;624 NINTH STREET, NW, SUITE 300, WASHINGTON, DC, 20001-5303, US

(73) Assignee: ARIANCE, Paris (FR)

(21) Appl. No.: 11/995,670

(22) PCT Filed: Jul. 11, 2006
(86) PCT No.: PCT/FR2006/001716

§ 371 Date: Jul. 28, 2008

(30) Foreign Application Priority Data
Jul. 12, 2005 (FR) 0507436

(51) Int. Cl. H02B 1/24

(52) U.S. Cl. 307/127

(57) ABSTRACT

The invention relates to method of safely starting a vehicle, comprising the following steps, consisting in: connecting either of the two input/output terminal pairs (ES1, ES2) or (ES3, ES4) to the run down battery (5) and the other input/output terminal pair (ES1, ES2) or (ES3, ES4) to the power source (2) independently of polarity, the connection means being open; detecting the voltage and polarity at the terminals of each of the pairs and comparing the voltages at the terminals (ES1, ES2) and (ES3, ES4) with a pre-determined threshold value; and configuring the links of the connecting means between the terminals of the two terminal pairs such that terminals of the same polarity can be connected to one another using conductive links, at least one of which is controlled by a general switch (8).

The present invention relates to a method and a device for electric assistance in starting a vehicle with an electric starter having problems starting.

It is applicable more particularly, but not exclusively, to motorcycles, but may also be extended very advantageously to any system comprising a heat engine, an electric starter and a battery such as, for example, personal watercrafts or snowmobiles, or even lawn mowers.

It is also applicable to hybrid vehicles comprising an electric and heat engine.

Currently, the large majority of heat engine vehicles use a starter and a battery upon start-up. Poor weather conditions, a run down battery, wear and tear of the vehicle, deterioration of the spark plugs and spark plug wires . . . sometimes make it impossible to start the engine without outside electric assistance.

Yet it has been observed that starting up these vehicles, even when piston displacement is small, requires a quite substantial current (often greater than several dozen amperes, with intensity peaks often greater than 100 amperes). This start-up intensity is much greater than the current required to charge the battery (often lower than 5 amperes).

Resolving the issue of start-up assistance is therefore a very different problem from that of charging batteries, where a much weaker current is sufficient, but for a longer time.

Start-up assistance is traditionally provided thanks to a charged booster battery and a bundle of electric cables connecting the terminals of this charged booster battery to the terminals of the run down battery.

Unfortunately, due to the strong power to be transferred and the possibility of connection errors, this principle is relatively dangerous and can create difficulties or even serious accidents.

Moreover, the alligator clips generally used are not adapted for particular usage, such as for motor scooters where the terminals are relatively small and difficult to access.

Furthermore, in some cases, in particular when the battery is greatly run down or when the battery is damaged, if the intensity of the current is not limited, it may reach several hundred amperes, which may cause fires and, in some cases, explosions.

In general, one knows that numerous patents exist for battery chargers, such as U.S. Pat. No. 5,640,076 or U.S. Pat. No. 5,715,156, for example, but these battery chargers are not designed to allow rapid and efficient start-up of a heat engine in a reduced bulk without risk.

U.S. Pat. No. 6,632,103 proposes a connecting circuit comprising an electronic package. This electronic package makes it possible to detect a connection error, but comprises nothing which makes such an error impossible.

The existing automatic systems comprising protection against changes of polarity do not allow passage of very strong currents and therefore cannot be used to start a heat engine. Indeed, the relays generally used have two main characteristics:
a maximum cut-off current Imc,
a maximum current after closure of the contacts Ifc.

However, it has been noted that the current Ifc is generally approximately twice the Imc. For example, the relays traditionally used in the automobile industry have a maximum cut-off current equal to 75 amperes while the maximum current allowable after closure of the contacts is equal to 150 amperes. This is due to the fact that during closure of the contacts, electric arcs form and rapidly deteriorate the contacts, which stick together and become inoperative.

Moreover, these systems do not allow a completely safe connection of the charged battery with a completely run down or damaged battery. Indeed, when a battery is completely run down, it is difficult to define its polarity automatically.

The present invention aims to resolve these major drawbacks by proposing an original method and device which are especially well-adapted to providing start-up assistance for heat engines comprising an electric starter and needing energy assistance for start-up.

To this end, it also proposes a safe start-up method for a vehicle provided with an electric starter whereof the battery is at least partially run down, or having difficulties starting up, this method using a safe interface comprising at least two input/output terminal pairs each able to be connected indifferently to said run down battery or to another source of electric energy and independently of polarity, said interface comprising voltage and polarity measurement means of the terminals of each of the pairs as well as connection means comprising a general switch, these connection means connecting the two pairs of terminals which, depending on the polarities detected, provide a connection between the terminals of identical polarity.

According to the invention, this method is characterized in that it comprises the following steps:
a. connecting either of the two input/output terminal pairs to said run down battery and the other input/output terminal pair to the power source independently of polarity, the connection means being open;
b. detecting the voltage and polarity at the terminals of each of the pairs and comparing the voltages T1 and T2 with a predetermined threshold value TS,
c. establishing connections between the terminals of the two pairs of terminals with the help of said connection means such that the terminals of the same polarity can be connected to each other by conductive links whereof at least one is controlled by said general switch,
d. closing of said general switch being done only the case where the two values of the two voltages detected are greater than said threshold value TS,
e. limiting of the intensity I of the current circulating in the conductive link controlled by the general switch (8) at a predetermined maximum value Imax,
f. starting of the engine with the help of a start-up control of the starter.

Thanks to these arrangements, the invention makes it possible to pre-arm the circuits and pre-position the contacts so as to ensure correct polarity, then to close the general switch (8) once the systems are armed and in position. One can thus accept, without deterioration, much stronger currents in a reduced environment and at a low cost.

It significantly improves safety by measuring the two voltages T1 and T2 existing at the terminals of the charged battery and those of the run down battery and by only allowing closing of the general switch if the two voltages T1 and T2 are greater than a predetermined threshold TS. This has the advantage of avoiding overly significant differences in voltage between the charged battery and the run down battery and therefore avoiding the peak of intensity which may occur when one connects a charged battery with a completely run down battery.

Advantageously, the following features can be integrated into the previously defined method:
the step involving closing of said general switch also comprises an earlier step involving actuating a simple manual control, such as a push button, for instance.
the step involving closing said general switch also comprises an earlier verification step consisting of verifying, with the help of at least one visual and/or auditory indicator, the value of the voltage level existing at the terminals of the interface, actuation of said simple manual control only being done if the displayed voltage values are deemed sufficiently high by the operator.
the step involving closing of said general switch also comprises an earlier step involving inversion of the direction of the main current in the case where the direction of the current does not correspond to the predetermined direction to enable usage of a polarized general switch such as, for example, a power transistor at a reduced price, operating in only one direction.

The presence of a push button on the safe interface and illuminated bulbs indicating the approximate value of the two voltages makes it possible to allow final contact of the general switch only if the indicated voltages T1 and T2 are sufficient. This also increases safety by only allowing the connection relative to the strong currents once the operator has verified that everything is operating correctly.

The invention also concerns a safe interface for starting up a heat engine vehicle provided with an electric starter whereof the battery is at least partially run down, or having difficulties starting up, this interface comprising:
at least two pairs of input/output terminals,
at least one connection means enabling each pair of input/output terminals to be connected indifferently on said run down battery or on another electrical energy source in complete safety and independently of polarity,
at least one means for measuring the voltage and polarity of the terminals of each pair,
at least one means for commutation between the two pairs of terminals which, depending on the polarities detected, provides a connection between the terminals having identical polarity only if the values of said measured voltages T1 and T2 are greater than a predetermined threshold Tmin.

Advantageously, the following aspects can be integrated into the previously described device:
said interface also comprises a simple manual control allowing closing of said general switch.
said interface also comprises a visual and/or auditory indicator of the value of the voltage level existing at the terminals of the interface.
said interface also comprises a means for limiting the intensity I circulating in the connection established by said commutation means.
said limiting means limits the intensity I depending on an increasing function of time.
said limiting means is designed such that the intensity I progressively and continuously increases from a value I=Imin at a moment T0 up to an intensity I=Imax at a moment T1, the values of Imin and Imax as well as the moment T1 being predetermined values.
said primary energy source required for start-up is a charged battery.
said interface also comprises a pair of two additional terminals which can be connected to a commercial battery charger.
said general switch is made up of a power transistor only operating in a direction of the main current, connected to at least one current rectifying means ensuring the correct direction of the current I in the power transistor in all cases.
at least one end pair (AI1, AI2) and/or (BI1, BI2) of said cables A and/or B, is a couple of electrically-insulated female connectors.
at least one connecting cable A comprises, in place of the two alligator clips (ABC1, ABC2), two ends able to be permanently fixed on the battery of the motorized vehicle.

One embodiment of the invention will be described below as a non-limiting example, in reference to the appended drawings in which:

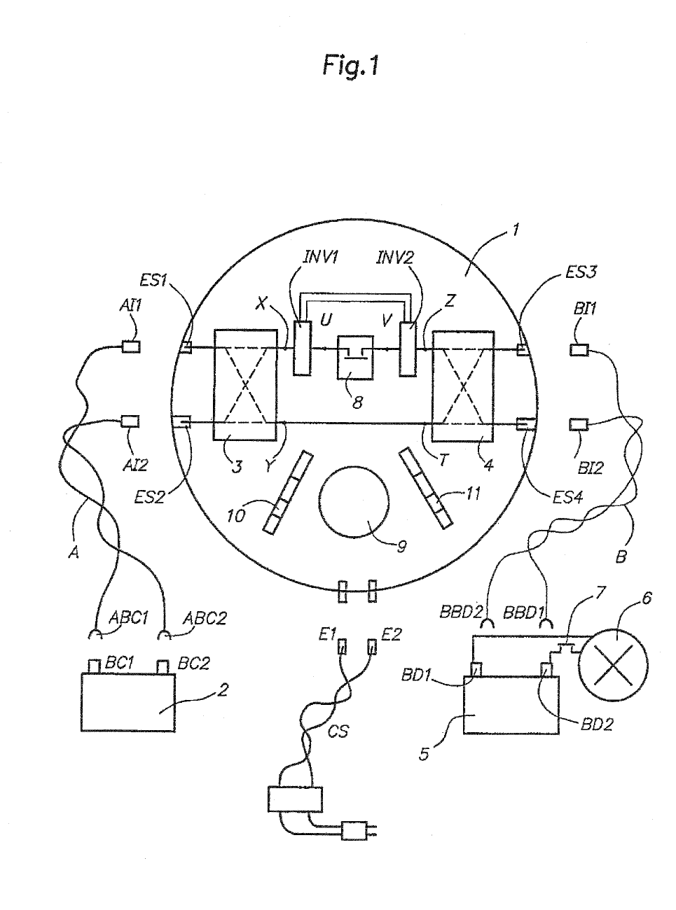

FIG. 1 diagrammatically illustrates a top view of a safe interface according to the invention,

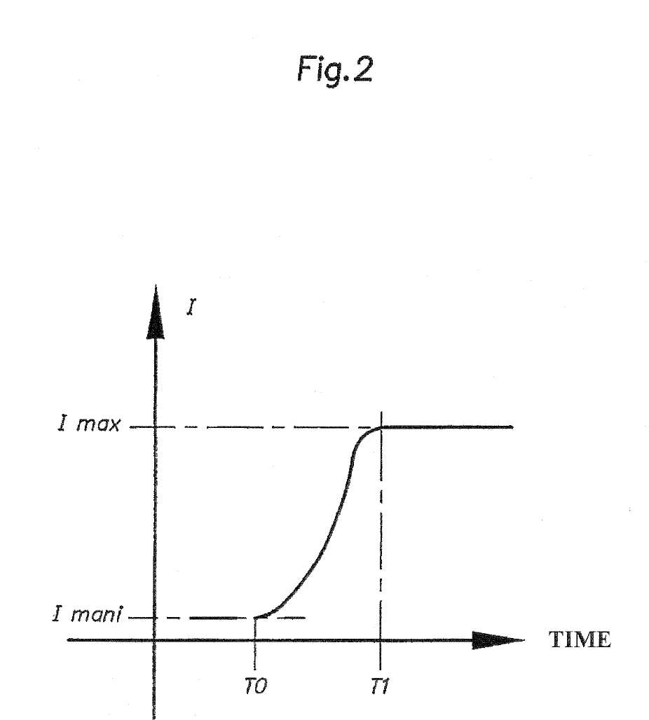

FIG. 2 illustrates an example of intensity I limitation over time,

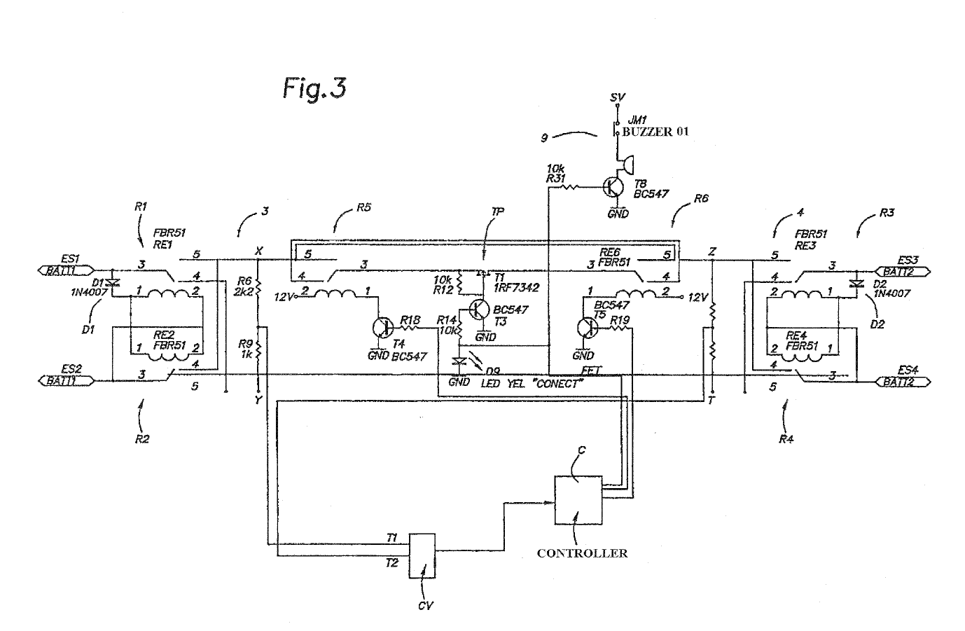

FIG. 3 is a summary diagram of an example of electronic circuit,

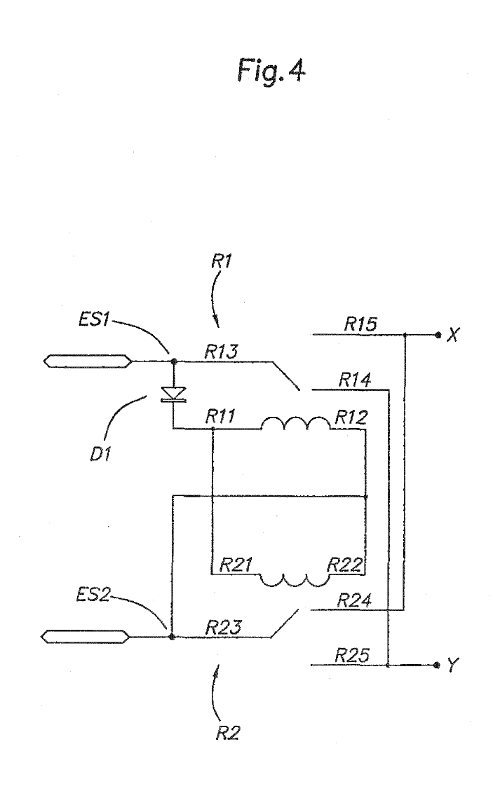

FIG. 4 is a summary diagram of a rectifier,

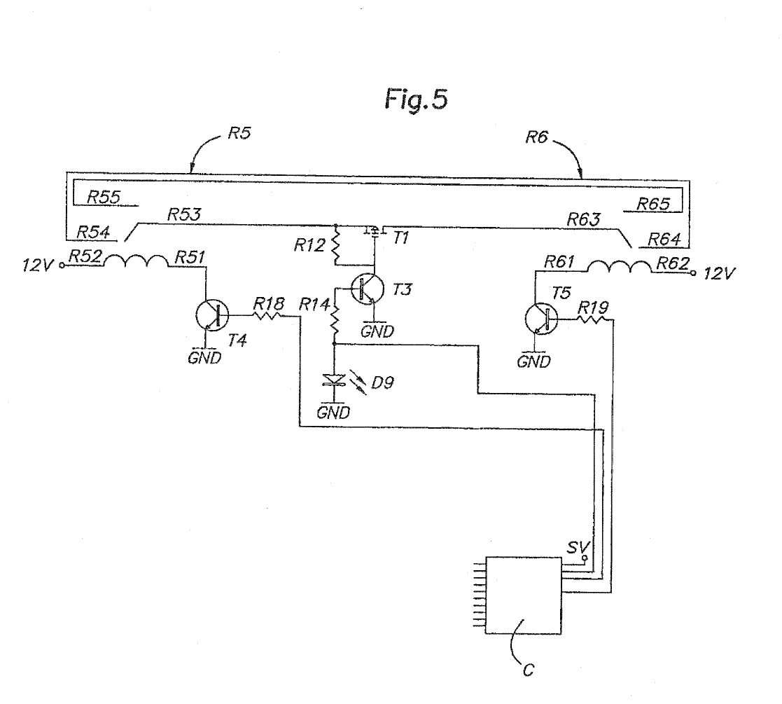

FIG. 5 is a summary diagram of an example illustrating a general switch connected to a current rectifying circuit.

The embodiment described below as shown in FIG. 1 makes it possible to actuate an electric starter (6) comprising a start-up contactor (7) which is usually electrically powered by a battery (5) comprising two terminals BD1 and BD2.

A properly charged booster battery (2) is used here as additional energy source. Said booster battery comprises two terminals BC1 and BC2.

A safe interface (1) comprises two pairs of input/output terminals (ES1, ES2) and (ES3, ES4).

Two bundles of cables (A) and (B), each respectively comprising one pair of terminals (AI1, AI2) and (BI1, BI2), on one hand, and a pair of alligator clips (BC1, BC2) and BBD2, BBD1) on the other hand make it possible to connect the two input/output pairs (ES1, ES2) or (ES3, ES4) indifferently to either of the batteries (2) or (5) without worrying about the polarities by connecting the pair of terminals (ES1, ES2) of the safe interface to the pair of terminals (BC. BC2) of the battery (2) or to the pair (BD1, BD2) of the battery (5) and the pair of terminals (ES3, ES4) of the safe interface to the pair of terminals (BD1, BD2) of the battery (5) or to the pair (BC1, BC2) of the battery (2).

The safe interface (1) comprises a first rectifier assembly (3) making it possible to rectify the polarity existing at the terminals (ES1, ES2) to obtain, at the output terminals of this first rectifier assembly (X, Y), a predefined polarity.

The safe interface (1) also comprises:
a second rectifier assembly (4) making it possible to rectify the polarity existing at the terminals (ES3, ES4) to obtain, at the output terminals of this first rectifier assembly (Z, T), a predefined polarity identical to that existing at the terminals (X, Y).
a general switch (8) which in this embodiment is formed by a power transistor (TP) only operating in one direction and comprising two terminals U and V.
an inversion assembly comprising two inverters (INV1) and INV2) connecting either terminal X with terminal U and terminal V with terminal Z or terminal U with terminal Z and terminal V with terminal X.
a means making it possible to measure the voltage T1 existing at the terminals (ES1, ES2), and a means for measuring the voltage T2 existing at the terminals (ES3, ES4).

a control means (CV) comparing the values of the voltages T1 and S2 relative to a predetermined threshold value TS and comparing the voltages T1 and T2 to each other.
a controller C receiving the information from the control means (CV) and controlling the operation of the inverter group and the closing of the general switch (8) according to the voltages T1 and T2.
a means (not shown) limiting the intensity of the current going through the general switch (8).
indicators (10) and (11) comprising indications of the value of the voltage T1 and T2, respectively.
a push button allowing closing of the general switch.

With the help of all of the means presented above, the method for starting up a starter (6) having difficulties starting is the following:
connecting the cable A to the interface (1) by connecting, for example, the terminal AI1 with the terminal ES1 and the terminal AI2 with the terminal ES2
connecting the cable B to the interface (1) by connecting, for example, the terminal BI1 with the terminal ES3 and the terminal BI2 with the terminal ES4
connecting the cable A to the battery (2), for example, by connecting, for instance, the terminal ABC1 to the terminal BC1 and the terminal ABC2 to the terminal BC2
connecting the cable B to the battery (5), for example, by connecting, for instance, the terminal BBD2 with the terminal BD1 and the terminal BBD1 with the terminal BD2
verifying, on the indicators (10) and (11), that the voltages T1 and T2 are much greater than the predefined threshold (TS), for example 7 volts.
the rectifier assembly (3) may shift the polarity to have a defined polarity at the terminals X, Y
the rectifier assembly (4) may shift the polarity to have a defined polarity at the terminals Z, T identical to that existing in (X, Y)
one pushes on a push button (9) to allow closing of the general switch
one starts the starter by actuating the general start-up switch (7)

FIG. 1 also shows a standard charger (CS) making it possible to power the terminals E1 and E2 of the safe interface from an electrical outlet from the sector.

FIG. 2 shows an example of predetermined evolution of limitation of the current I according to the time between the moment of start-up t0 and the moment t1.

FIG. 3 shows, in more detail, the electrical diagram of an embodiment according to the invention. The first polarity rectifying assembly (3) comprises two relays R1 and R2 and a diode D1 rectifying the polarity of the current coming from the pair of terminals (ES1, ES2) to connect the pair of terminals (X, Y) with a predefined polarity. The assembly formed by the relays R3 and R4 and the diode D2 constitutes the second rectifier (4) and rectifies the polarity existing at the pair of terminals (ES3, ES4) to connect the pair of terminals (Z, T) with a predefined polarity respectively identical to that of the pair (X, Y). The sensor CV measures and compares the voltage at each input (T1) and (T2) in order to control a controller C which, in turn, will control the positioning of the relays R5 and R6 to orient the current going through the power transistor in the right direction. The controller C also controls closing of the power transistor FP, which here constitutes the general switch (8).

FIG. 4 shows a detail of the diagram of the first polarity rectifying assembly (3) constituted by the two relays R1 and R2 as well as the diode D1. The relay R1 comprises the two charge ports to control the relay R1: (R11 and R12). The relay R1 comprises a general switch connecting the terminal R13 either with the terminal R15 or with the terminal R 14. Likewise, the relay R2 comprises the two charge ports to control the relay R1: (R21 and R22). The relay R2 comprises a general switch connecting the terminal R23 either with the terminal R25 or with the terminal R24.

FIG. 5 shows a detail of the electrical diagram and the corresponding constituent parts relative to the system for potentially inverting the direction of the current and potentially closing the general switch (8). The relay R5 comprises the two charge ports for controlling the relay R5: (R51 and R52). The relay R5 comprises a general switch connecting the terminal R53 either with the terminal R55 or with the terminal R44. Likewise, the relay R6 comprises the two charge ports for controlling the relay R6: (R61 and R62). The relay R6 comprises a general switch connecting the terminal R63 either with the terminal R65 or with the terminal R64.

The two ends (AI1 and AI2) of the cable A are connected to the terminals ES1 and ES2. It should be noted that these two ends of the cable A could also have been connected to the other pair of terminals of the interface (ES3, ES4). The other end of the two lead cable A is connected through clips (ABC1, ABC2) to the terminals of the charged battery without worrying about polarity issues.

If the voltage T1 measured at the terminals (ES1, ES2) is below the predefined threshold, for example 7 volts, then the controller C is instructed to leave the general switch (8) (here the power transistor TP) in the open position. If the voltage T1 is above a predefined threshold TS, for example 7 volts, and if the polarity between the terminals ES1 and ES2 is such that it corresponds to the predefined polarity in (X, Y) while the diode D1 allows the current to pass into the relay coil R1 (terminals R11, R12) and into the relay coil R2 (terminals R21, R22). This results in putting the terminal R13 in communication with the terminal R15 and the terminal R23 with the terminal R25. In this case, the terminals ES1 and ES2 are connected without inversion with the terminals X and Y, respectively.

If the polarity at the terminals ES1, ES2 is inverse from that predefined at the terminals X. Y, then the diode D1 blocks the passage of the current. The coil is therefore not powered and the general switch of the relay connects the terminal R13 with the terminal R14. Likewise, if the polarity at the terminals ES3, ES4 is inverse from that predefined at the terminals Z, T, then the diode D2 blocks the passage of the current. The coil is therefore not powered and the general switch of the relay connects the terminal R23 with the terminal R24.

Thus regardless of the polarity existing at the terminals (ES1, ES2), the polarity at the terminals (X, Y) will indeed be that which is desired and predefined.

Bulbs (10) arranged from the side of the terminals connected to the charged battery light up, very clearly showing the charge level of the battery which will serve as an additional electrical power source. Insofar as the voltage read T1 is deemed sufficient, one then connects the terminals (BD1, BD2) of the battery (5) of the vehicle having the start-up problems to the two terminals remaining free on the safe interface (ES3, ES4) using the cable B, without worrying about polarity issues. A relay assembly R3 and R4 as well as a diode D2 assembled like the relay assembly R1, R2 and diode D1 makes it possible to ensure a predefined polarity at the terminals Z, T identical to that of the terminals (X, Y).

The general switch (8), here a power transistor (TP), is initially in the open position. It remains in the open position as long as the order to close is not given.

The relays are therefore thus pre-positioned without risk of the appearance of an electric arc in the area near the power contacts.

This order to close the general switch (8) is given either through action on a push button (9) or after a predetermined time period has passed.

It is also possible to limit the passing current I passing through this general switch at a maximum value according to the time as shown in FIG. 2 by interposing, in series in the power circuit, a standard “polyswitch” type element commercially available.

It is also possible to limit the intensity of the current I in two different ways depending on whether the push button (9) is in the open or closed position, for example to admit a current of a higher intensity I2 when the push button is pushed in, and only allow a current of weaker intensity I1 when the push button is not pushed in. It is also possible to define the values I1 and I2 according to the time, this time being defined from the moment when the push button (9) is pushed in. This has the advantage of having a more gradual operation of the interface and avoiding overvoltages and/or over-currents.

It is also possible to provide for an additional supply of electric energy no longer based on a booster battery but from the sector. A standard charger (CS) operating from alternating current coming from the sector is connected to the two terminals E1 and E2. This power source is connected in the same way and makes it possible to power the terminals ES1, ES2 or ES3, ES4 taking polarity into account. In this case the maximum available current will generally be lower and will depending on the possibilities of the charger CS.

In this example, the general switch (8) is formed by a power transistor sensitive to the direction of the power current. Two inverters (INV1) and (INV2) on each side of the power transistor are placed to correct the direction of the power current if needed.

Each inverter INV1 or INV2 is formed by an inverter relay R5 and R6, respectively, whereof the coil is controlled by the controller C. The inverter INV1 is formed by the relay R5. If the voltage T1 measured at the terminals ES1, ES2 is greater than the voltage T2 measured at the terminals (ES3, ES4), when the controller gives the order to actuate the coil (R52, R51) of the relay R5 modifying the resting position of the contactor and connecting the terminal R53 to the terminal R55, while the coil (R61, R62) of the relay R6 is not actuated, which maintains the connection between the terminals R63 and R64. Because of this, the current circulates in the proper direction for the power transistor.

In the contrary case, where the voltage T2 is greater than the voltage T1, the controls are inverted so that the direction of the current in the power transistor is the same.

It should be noted that other systems can be integrated in place of the current inverters INV1 and INV2 to achieve the same result. Likewise, other configurations can be imagined to carry out the same functions as the general switch (8).

This method and this device according to the invention are suitable for helping with the start-up of a motorcycle which has difficulties starting up by providing, simply and safely, the electric power needed to start the vehicle. However, this method and device are applicable in a variety of fields or can be used in systems comprising a need to supply significant current into polarized circuits, such as, for example, hybrid vehicles or lawn mowers.

1. Safe start-up method for a vehicle provided with an electric starter whereof the battery is at least partially run down, or having difficulties starting up, this method making use of an interface comprising at least two pairs of input/output terminals each of which can be connected indifferently to said run down battery or to another electrical energy source and independently of polarity, this interface comprising means for measuring the voltage T1 and T2 and polarity of the terminals of each of the pairs as well as connection means comprising a general switch, these connection means connecting the two pairs of terminals so as to provide, according to the polarities detected, a connection between the terminals of identical polarity, said method comprising:
a) connecting either of the two input/output terminal pairs, to said run down battery and the other two input/output terminal pairs to said energy source, and independently of polarity, the connection means being open,
b) detecting the voltage T1 and T2 and the polarity at the terminals of each of the pairs and comparing the voltages T1 and T2 with a predetermined threshold value TS,
c) establishing a connection between the terminals of the two pairs of terminals using said connection means such that the terminals of the same polarity can be connected to each other by conductive links at least one of which is controlled by said general switch,
d) closing of said general switch being done only in the case where the two values of the two detected voltages T1 and T2 are above said threshold TS,
e) limiting the intensity I to a predetermined maximum value Imax,
f) starting the motor with the help of a start-up control of the starter.

2. Safe start-up method for a vehicle according to claim 1, wherein the step involving closing said general switch also comprises an earlier step consisting of actuating a simple manual control.

3. Safe start-up method for a vehicle according to claim 2, wherein the step involving closing of said general switch also comprises a step involving verifying, with the help of at least one visual and/or auditory indicator, the value of the voltage level existing at the terminals of the safe interface and actuating said simple manual control only if the voltage values indicated are deemed sufficient by the operator.

4. Safe start-up method for a vehicle according to claim 1, wherein the step involving closing of said general switch also comprises a step consisting of inverting the direction of the main current in the case where the direction of the current does not correspond to a predetermined direction in order to enable usage of a polarized general switch such as a power transistor at a reduced cost, operating in only one direction.

5. Safe interface for start-up of a motor vehicle provided with an electric starter whereof the battery is at least partially run down, or having difficulties starting up, this interface comprising at least two pairs of input/output terminals, said safe interface comprising:
at least one connection means allowing each pair of input/output terminals to be, completely safely, connected indifferently to said run down battery or to another electric energy source and independently of polarity,
at least one means for measuring the voltage and polarity of the terminals of each of the pairs,
at least one limiting means maintaining the value of the intensity I below a predetermined threshold Imax,
at least one commutation means between the two pairs of terminals which, according to the polarities detected, only provides a connection between the terminals of identical polarity if the values of said measured voltages T1 and T2 are greater than a predetermined threshold Tmin.

6. Interface according to claim 5, wherein said interface also comprises a simple manual control allowing closing of a general switch.

7. Interface according claim 5, comprising at least one visual or auditory indicator of the value of the voltage level existing at the terminals of the interface.

8. Interface according to claim 5, comprising at least one means limiting the intensity I circulating in the connection established by the abovementioned commutation means.

9. Interface according claim 5, wherein said limiting means limits the intensity I according to an increasing time function.

10. Interface according to claim 5, wherein said limiting means is designed such that the intensity I increases gradually and continuously from a value I=Imin at a moment T0 up to a value I=Imax at a moment T1, the values of Imin and Imax as well as the moment T1 being predetermined.

11. Interface according to claim 5, characterized in that said main energy source needed for start-up is a charged battery.

12. Interface according to claim 5, wherein said interface also comprises a pair of two additional terminals able to be connected to a commercial battery charger.

13. Interface according to claim 5, wherein said general switch is made up of a power transistor only operating in a direction of the main current, connected to at least one current rectifying means ensuring the correct direction of the current I in the power transistor in all cases.

14. Interface according to claim 5, wherein at least one end pair of said cables, is a pair of electrically insulated female connectors.

15. Interface according to claim 5, wherein at least one connecting cable A comprises, in place of two alligator clips, two ends able to be fixed permanently to the motor vehicle.
